(19) United States
(12) Patent Application Publication
(10) Pub. No.: US 2008/0079846 A1
(43) Pub. Date: Apr. 3, 2008

(54) DIGITAL CAMERA OF COLLAPSIBLE TYPE

(75) Inventor: Kazuo IKARI, Asaka-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 11/863,654

(22) Filed: Sep. 28, 2007

(30) Foreign Application Priority Data
Sep. 28, 2006 (JP) 2006-265641

(51) Int. Cl. H04N 5/225

(52) U.S. Cl. 348/373; 348/E05.026

(57) ABSTRACT

A digital camera of a collapsible type includes a camera body. A lens barrel is movable back and forth relative to the camera body. An image sensor module is incorporated in the camera body, for detecting object light from the lens barrel. A sensor support supports a rear surface of the image sensor module in the camera body. An optical low-pass filter is disposed between the lens barrel and the image sensor module, for passing the object light. The optical low-pass filter is pressed backwards by the lens barrel when the lens barrel becomes contained in the camera body. A rubber tube is shiftable by compression and extension, and has a first end secured to the sensor support, and a second end secured to the optical low-pass filter, for covering a light path of the object light.

### BACKGROUND OF THE INVENTION

1. Field of the Invention

The present invention relates to a digital camera of a collapsible type. More particularly, the present invention relates to a digital camera of a collapsible type in which degradation of image quality can be prevented in occurrence of dust stuck on a surface.

2. Description Related to the Prior Art

An image sensor is known, such as CCD, C-MOS and the like, and receives light incident on a receiving surface for conversion into an electric signal. If dust sticks on the receiving surface of the image sensor, degradation of image quality occur. In view of this, an image sensor module as a package of the image sensor is available commercially. A package frame of the image sensor module is used to contain the image sensor. A transparent cover of glass encloses the package frame.

Also, the use of an optical filter of any of various types is known with the image sensor module, such as an optical low-pass filter, infrared cut filter and the like. An optical filter is disposed near to the image sensor module, and operates for eliminating moire, and for other various purposes of improvement of image quality.

Resolving power of the image sensor has increased more and more in the course of technological development. A pitch of pixels in the image sensor is decreasing according to intended reduction of size of the image sensor. However, there arises a problem of dust in a small size which has not been considered so far.

There are attempts of minimizing the amount of dust of the image sensor module particularly by manufacturers of the image sensor module. However, complete elimination of dust is impossible. Furthermore, it is likely in posterior steps to stick dust on the image sensor module, for example in assembly of a digital camera with the image sensor. A second manufacturer of a digital camera or other optical instrument requires installation of dust preventing structures in a manufacturing system to eliminate and preventing sticking of dust. However, maintenance of safety against dust is more difficult in the second manufacturer than the first manufacturer supplying the image sensor.

If dust sticks on an outer surface of the image sensor module, images are degraded, even after prevention of entry of dust into the image sensor module. A problem of dust on a filter or other outer elements remains irrespective of the structure of the image sensor module.

JP-A 11-243187 discloses an improved method of producing the image sensor module in which degradation of images is prevented. Dust sticking on an outer surface has a comparatively large size than dust entering the image sensor module, and will influence the image quality the more considerably. U.S. Pat. No. 7,006,138 (corresponding to JP-A 2002-204379) discloses eliminating of dust after assembly of the image sensor module. A piezoelectric element is attached on a periphery of a cover of glass disposed on the image sensor module in the outermost position The piezoelectric element vibrates the glass of cover to shake off dust.

JP-A 11-243187 discloses a method of a plurality of filters of quartz are laid on one another. The image sensor is tightly enclosed with the filters. A distance to the image sensor from the filters is kept long for the purpose of preventing a problem of dust sticking on or between the filters. However, the method has a problem of degradation of image quality, because a distance to the image sensor is not sufficient even with the total thickness of the filters. Dust on the filters may be focused on and apparently detected by the filters.

The effect of U.S. Pat. No. 7,006,138 (corresponding to JP-A 2002-204379) is limited in view of a large space and high cost. Vibration of the piezoelectric element on the cover of the image sensor module is insufficient for eliminating dust with an adhesive property or dust which becomes adhesive when moistened. Also, the image sensor module must be vibrated each time before photographing operation. Shutter chance may be lost because of longer time required from the shutter release to the image retrieval.

### SUMMARY OF THE INVENTION

In view of the foregoing problems, an object of the present invention is to provide a digital camera of a collapsible type in which degradation of image quality can be prevented in occurrence of dust stuck on a surface.

In order to achieve the above and other objects and advantages of this invention, a digital camera of a collapsible type includes a camera body. A lens barrel is movable back and forth relative to the camera body. An image sensor module is incorporated in the camera body, for photoelectric conversion of object light from the lens barrel. A sensor support supports the image sensor module in the camera body. An optical filter is disposed between the lens barrel and the image sensor module, for being pressed backwards by the lens barrel when the lens barrel becomes contained in the camera body. A tube is shiftable by compression and extension, has a first end secured to the sensor support, and a second end secured to the optical filter, for covering a light path of the object light.

The image sensor module includes an image sensor. A package body has the image sensor therein. A transparent cover is fitted on the package body, for enclosing the image sensor with the package body.

The optical filter includes an optical filter plate. A filter holder is secured to the tube, and has the optical filter plate fitted therein.

The lens barrel is movable between an advance position and a collapsed position, and the tube is deformed when the lens barrel moves to the collapsed position.

The tube is produced from elastic material, and comes to project in a radially outward direction when the optical filter is pressed backwards.

Furthermore, a compression coil spring is positioned inside the tube and about the light path, and has a first end secured to the sensor support, and a second end secured to the optical filter.

In one preferred embodiment, the tube is bellows.

Furthermore, a vent hole is formed in one of the image sensor module and the tube, for regulating an inner pressure of the tube with air. An air filter is fitted in the vent hole.

Furthermore, an air passageway has a first end connected with the tube. A pressure regulation container is flexible, connected with a second end of the air passageway, for compressing and extending upon shifting back and forth of the tube, to regulate an inner pressure of the tube with air.

The pressure regulation container includes air bellows.

The pressure regulation container is set in an extension position by an air flow when the tube is in a rear position, and set in a compression position by an air flow when the tube is in a front position. Furthermore, a biasing mechanism biases the pressure regulation container toward the compression position.

Accordingly, degradation of image quality in the digital camera of a collapsible type can be prevented in occurrence of dust stuck on a surface, because the image sensor module can be protected from dust by the tube combined with the optical filter.

### BRIEF DESCRIPTION OF THE DRAWINGS

The above objects and advantages of the present invention will become more apparent from the following detailed description when read in connection with the accompanying drawings, in which:

FIG. 1 is a vertical section illustrating a digital camera of a collapsible type;

FIG. 2 is a vertical section illustrating the digital camera of which a lens barrel is collapsed,

FIG. 3 is a perspective view illustrating a light chamber of the digital camera;

FIG. 4 is a perspective view illustrating the light chamber of the digital camera in a shortened state;

FIG. 5 is a vertical section illustrating another preferred digital camera having a bellows;

FIG. 6 is a vertical section illustrating still another preferred digital camera having a pressure regulation container; and

FIG. 7 is a vertical section illustrating the digital camera of FIG. 6 of which the lens barrel is collapsed.

### DETAILED DESCRIPTION OF THE PREFERRED EMBODIMENT(S) OF THE PRESENT INVENTION

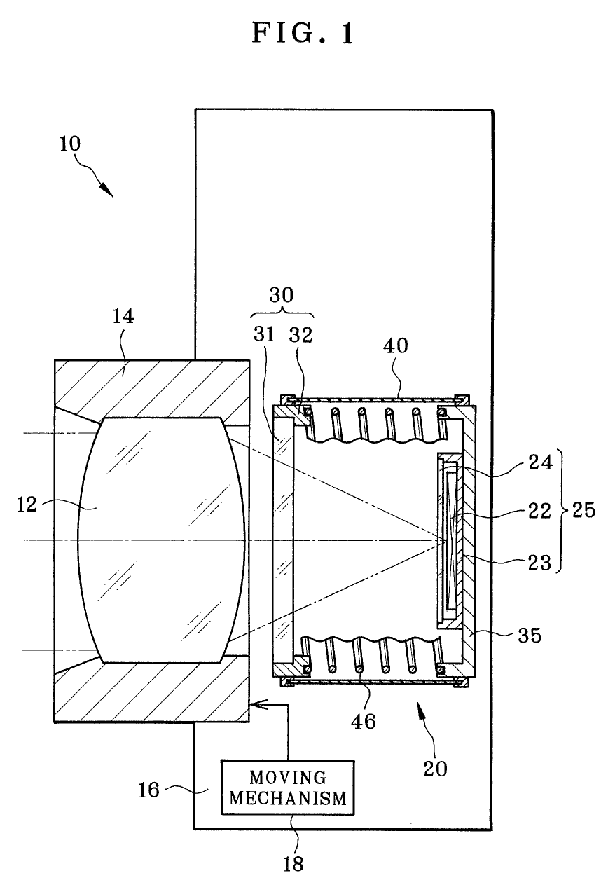

In FIG. 1, a collapsible type of digital camera 10 is illustrated. The digital camera 10 includes a camera body 16 and a lens barrel 14 disposed movable in the camera body 16 back and forth. A photographing lens 12 having lenses/lens groups is mounted in the lens barrel 14. To photograph an image, a user moves the lens barrel 14 from the camera body 16 forwards. After the image is photographed, the user moves the lens barrel 14 back into the camera body 16. A moving mechanism 18 for moving the lens barrel 14 is incorporated in the collapsible structure, which is effective in reducing a partial size of forward protrusion of the lens barrel 14.

An image sensor module 25 includes an image sensor 22 or image pickup device, a sensor holder or package body 23 for retention, and a transparent cover 24. The package body 23 supports the image sensor 22. The transparent cover 24 is positioned over the image sensor 22, attached to the package body 23, and encloses the image sensor 22 in a tight manner as a sensor package. The image sensor module 25 is so positioned that its center is set on an optical axis of the photographing lens 12.

An optical low-pass filter 30 is disposed behind the photographing lens 12 and positioned on its optical axis. The optical low-pass filter 30 consists of an optical low-pass filter plate of glass 31, and a filter holder 32 having a frame shape to hold the filter plate of glass 31.

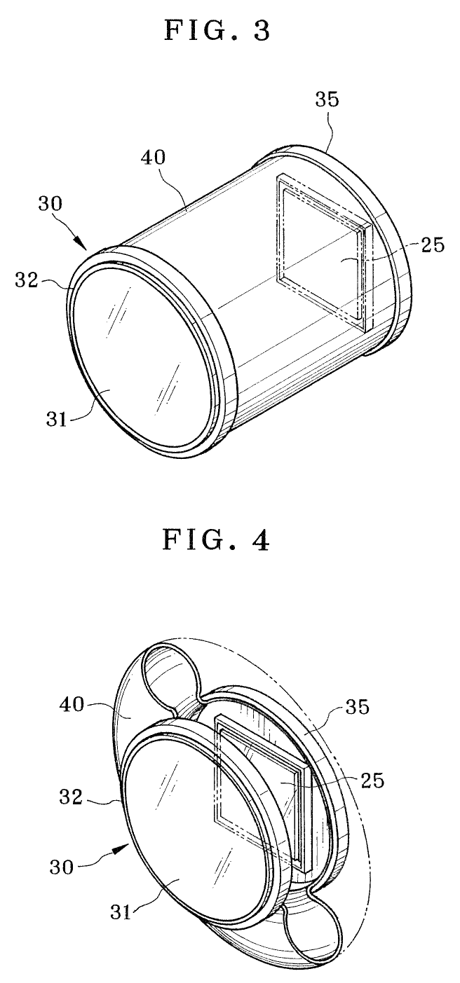

A base or sensor support panel 35 supports the image sensor module 25 secured thereto. In FIG. 3, a rubber tube 40 in a resilient form has a first end attached to the sensor support panel 35, and a second end attached to the optical low-pass filter 30. A light chamber 20 for image pickup is constituted by the sensor support panel 35, the optical low-pass filter 30 and the rubber tube 40. The rubber tube 40 defines a tightly enclosed space in the light chamber 20.

A compression coil spring 46 is disposed in the rubber tube 40 and extends between the sensor support panel 35 and the optical low-pass filter 30. The compression coil spring 46 operates to increase an interval between the sensor support panel 35 and the optical low-pass filter 30. This is an effect similar to that of the rubber tube 40. The use of the compression coil spring 46 is advantageous in additionally stabilizing the form of the light chamber 20 from the sensor support panel 35 to the optical low-pass filter 30.

The operation of the light chamber 20 is described now. Most of dust stuck on the optical low-pass filter 30 is harmful to object light passed through the photographing lens 12, because detected by the image sensor 22 as partial objects. However, the optical low-pass filter 30 with dust is positioned near to the rear end of the photographing lens 12. A distance of the optical low-pass filter 30 from the image sensor 22 is considerably long in the focusing of object light from the photographing lens 12 on the image sensor 22. Thus, local dust of the optical low-pass filter 30 is not focused on the image sensor 22 owing to the diffusion of light. No degradation in the image quality occurs even with the dust stuck on the optical low-pass filter 30.

Furthermore, should a user drop the camera erroneously to give shock to the lens barrel, damage can be reduced in the invention because part of the shock can be absorbed by the rubber tube 40.

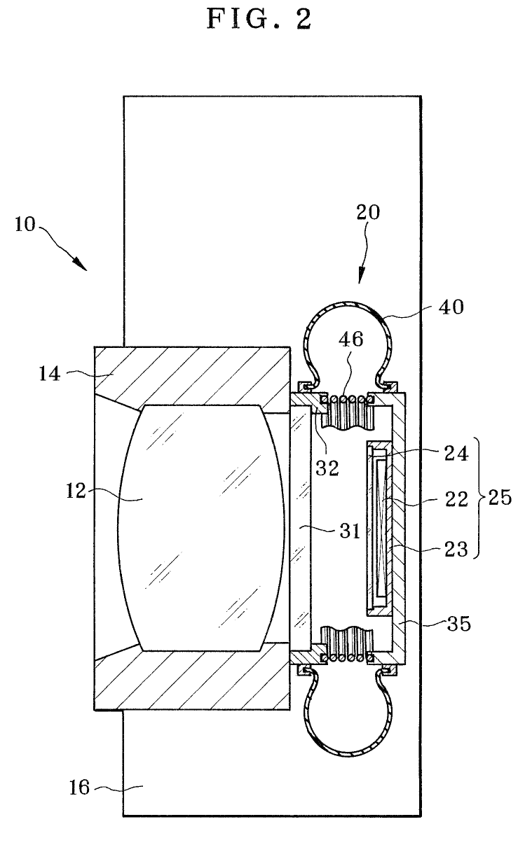

The movement of the lens barrel 14 into the camera body 16 is described now. In FIG. 2, the lens barrel 14 starts moving backwards into the camera body 16. A rear end of the lens barrel 14 contacts the filter holder 32 of the optical low-pass filter 30 and pushes the filter holder 32 back. In response, an interval between the filter holder 32 and the sensor support panel 35 decreases. The rubber tube 40 is shortened, and becomes larger in an outward direction as tightly enclosed air pushes the rubber tube 40 to the outside.

If the rubber tube 40 partially bends inwards in an incidental manner, the compression coil spring 46 prevents the rubber tube 40 from considerable deformation into a space where light passes. When the entirety of the rubber tube 40 deforms outwards to complete backward movement of the lens barrel 14 into the camera body 16, the rubber tube 40 comes to project as illustrated in FIG. 4 in a shape of a swim ring or doughnut in the periphery of the light chamber 20.

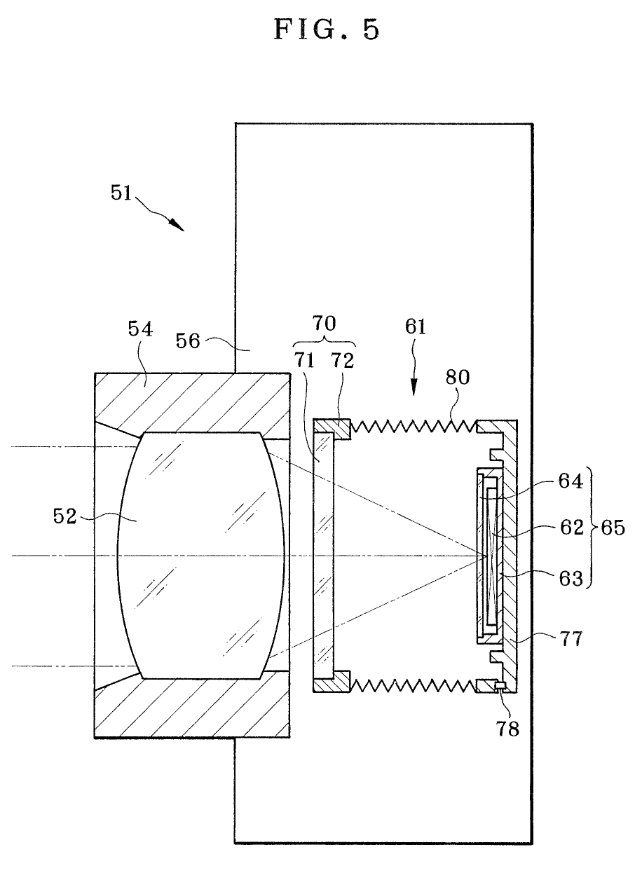

In FIG. 5, a collapsible type of digital camera 51 of another preferred embodiment is illustrated. Portions of the digital camera 51 except for a light chamber 61 for image pickup are the same as those of the digital camera 10. Elements similar to the above embodiments are designated with identical reference numerals. Effects against dust on an optical low-pass filter 70 are the same as the above embodiment.

A photographing lens 52 having lenses/lens groups has an optical axis. An image sensor module 65 is a package including an image sensor 62 or image pickup device, a sensor holder or package body 63 for retention, and a transparent cover 64. The image sensor 62 is so positioned that its center lies on the optical axis. The optical low-pass filter 70 is disposed behind the photographing lens 52, and includes an optical low-pass filter plate of glass 71, and a filter holder 72.

A base or sensor support panel 77 supports the image sensor module 65 of the packaged form. A bellows 80 or tube in a flexible form has a first end attached to the sensor support panel 77, and a second end attached to the optical low-pass filter 70. The light chamber 61 is constituted by the sensor support panel 77, the optical low-pass filter 70 and the bellows 80. The bellows 80 shifts to expand and compress, and defines a tightly enclosed space in the light chamber 61.

A rear end of the bellows 80 is attached tightly to the sensor support panel 77. A front end of the bellows 80 is attached to the filter holder 72 of the optical low-pass filter 70. The tightly enclosed space is defined by the attachment of the front and rear ends of the bellows 80. A vent hole is formed in the sensor support panel 77. An air filter 78 is fitted in the vent hole.

A lens barrel 54 becomes contained in a camera body 56 when image pickup is completed. The lens barrel 54 moves backwards. A rear end of the lens barrel 54 contacts and pushes the filter holder 72 backwards. Then an interval between the filter holder 72 and the sensor support panel 77 decreases, to cause inner air to flow outside through the air filter 78. The digital camera 10 is set up again to photograph another image. To move the lens barrel 54 forwards from the camera body 56, the bellows 80 expands and receives entry of air from the outside through the air filter 78. The air filter 78 prevents entry of dust, from which the bellows 80 can be kept free.

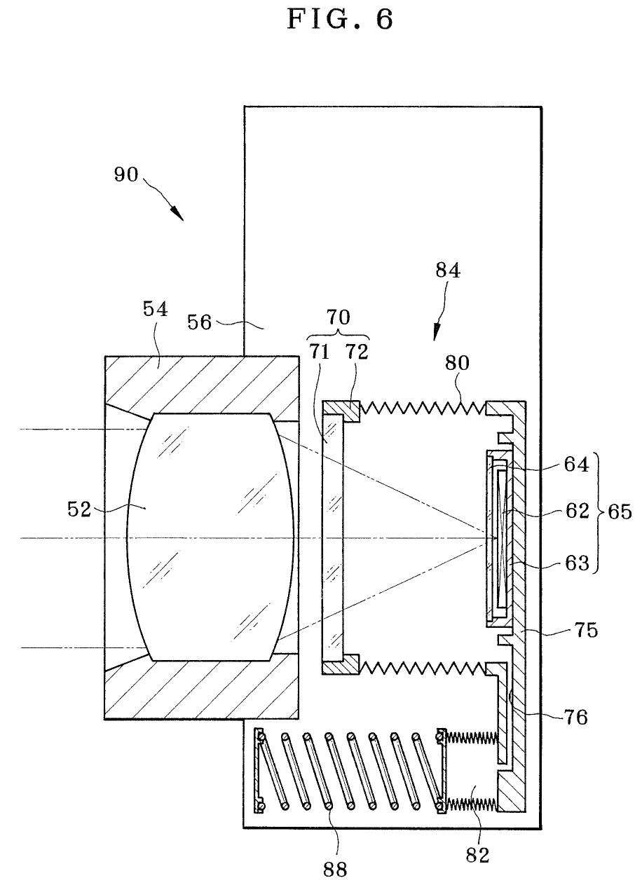

Another preferred collapsible type of digital camera 90 is described. In FIG. 6, a light chamber 84 for image pickup of the digital camera 90 is provided with a pressure regulation container 82 or air bellows. Elements similar to those of the above embodiment besides the light chamber 84 are designated with identical reference numerals.

In FIG. 6, a base or sensor support panel 75 is the rear of the light chamber 84. The pressure regulation container 82 is positioned on the sensor support panel 75 as well as the bellows 80. An air passageway 76 is formed to communicate between the inside of the bellows 80 and the inside of the pressure regulation container 82. A compression coil spring 88 for biasing presses the outer surface of the pressure regulation container 82 in a shortening direction for a smaller volume. The bellows 80 operates in a direction always to increase the interval between the sensor support panel 75 and the optical low-pass filter 70. In addition to this, the compression coil spring 88 exerts force to extend in such a manner that inner air causes the bellows 80 to extend forwards.

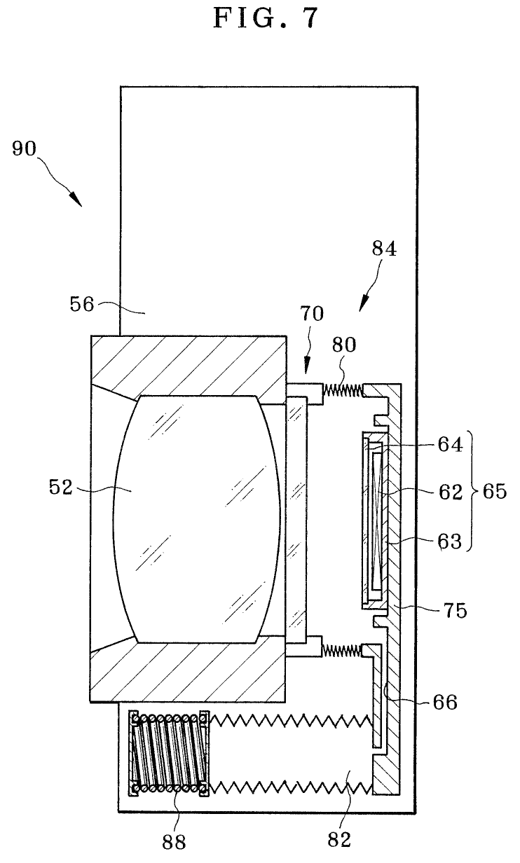

When the image pickup is ended, the lens barrel 54 is moved into the camera body 56. The rear end of the lens barrel 54 comes to contact the filter holder 72 upon the start of backward movement of the lens barrel 54. In FIG. 7, the interval between the filter holder 72 and the sensor support panel 75 decreases to increase the inner pressure of the enclosed air. The air flows out through the air passageway 76 at the sensor support panel 75, and enters the pressure regulation container 82.

The pressure regulation container 82 or air bellows expands to have a larger volume against the force of the compression coil spring 88 by the volume of air flowing from the bellows 80 in the compression. The bellows 80 becomes larger in the forward movement of the lens barrel 54 from the camera body 56. Air in the pressure regulation container 82 flows again into the bellows 80 through the air passageway 76.

The bellows 80 has force of recovery in its form. This force of the bellows 80 moves back the optical low-pass filter 70 to the vicinity of the rear end of the lens barrel 54 positioned forwards. It is possible to use the compression coil spring 88 positioned around the pressure regulation container 82 or air bellows. Also, it is possible to position a coil spring between the filter holder 72 and the sensor support panel 75 inside the bellows 80. Also, a coil spring can be positioned around the bellows 80.

The pressure regulation container 82 may be any one of various containers of a flexible shape, for example, a plastic bag, syringe and the like.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A digital camera of a collapsible type, comprising:
a camera body;
a lens barrel movable back and forth relative to said camera body;
an image sensor module, incorporated in said camera body, for photoelectric conversion of object light from said lens barrel;
a sensor support for supporting said image sensor module in said camera body;
an optical filter, disposed between said lens barrel and said image sensor module, for being pressed backwards by said lens barrel when said lens barrel becomes contained in said camera body; and
a tube, shiftable by compression and extension, having a first end secured to said sensor support, and a second end secured to said optical filter, for covering a light path of said object light.

2. A digital camera as defined in claim 1, wherein said image sensor module includes:
an image sensor;
a package body having said image sensor therein;
a transparent cover, fitted on said package body, for enclosing said image sensor with said package body.

3. A digital camera as defined in claim 2, wherein said optical filter includes:
an optical filter plate; and
a filter holder, secured to said tube, and having said optical filter plate fitted therein.

4. A digital camera as defined in claim 1, wherein said lens barrel is movable between an advance position and a collapsed position, and said tube is deformed when said lens barrel moves to said collapsed position.

5. A digital camera as defined in claim 4, wherein said tube is produced from elastic material, and comes to project in an outward direction when said optical filter is pressed backwards.

6. A digital camera as defined in claim 5, further comprising a coil spring, positioned inside said tube and about said light path, having a first end secured to said sensor support, and a second end secured to said optical filter.

7. A digital camera as defined in claim 4, wherein said tube is bellows.

8. A digital camera as defined in claim 7, further comprising:
a vent hole, formed in one of said image sensor module and said tube, for regulating an air pressure in said tube; and
an air filter fitted in said vent hole.

9. A digital camera as defined in claim 7, further comprising a pressure regulation container connected with said tube, for storing air from said tube when said tube compresses, and for supplying air to said tube when said tube extends.

10. A digital camera as defined in claim 9, wherein said pressure regulation container includes:
air bellows shiftable by compression and extension; and
a biasing mechanism for biasing said air bellows in a direction for said compression.
